(19) United States
(12) Patent Application Publication
(10) Pub. No.: US 2026/0217105 A1
(43) Pub. Date: Jul. 30, 2026

(54) MOTOR VEHICLE COMPRISING A FRONT AXLE DRIVABLE VIA A DRIVE ARRANGEMENT

(71) Applicant: AUDI AG, Ingolstadt (DE)

(72) Inventors: Bernhard KOHN, Lenting (DE); Marko LINDNER, Kipfenberg (DE); Christian MEIXNER, Ingolstadt (DE); Korbinian WEBER, Ingolstadt (DE)

(21) Appl. No.: 19/453,943

(22) Filed: Jan. 20, 2026

(30) Foreign Application Priority Data
Jan. 30, 2025 (DE) 102025103377.3

(51) Int. Cl. B60K 7/00; B60K 17/04; B60K 1/00

(52) U.S. Cl. CPC B60K 7/0007; B60K 17/043; B60K 2001/006; B60K 2007/0038; B60K 2007/0092

(57) ABSTRACT

A motor vehicle is disclosed, and may include a front axle configured to be driven via a drive arrangement, a power supply device, and a coolant and/or lubricant supply device. The drive arrangement may include a first electric motor, a first gearbox, a first drive hub coupled to the first electric motor, a second electric motor, a second gearbox, and a second drive hub coupled to the second electric motor. The power supply device and the coolant and/or lubricant supply device may be arranged in a common structural unit. The first electric motor and/or the first gearbox may be connected to the coolant and/or lubricant line supply device via a first coolant and/or lubricant supply line arrangement, and the second electric motor and/or the second gearbox may be connected to the coolant and/or lubricant supply device via a second coolant and/or lubricant supply line arrangement.

### BACKGROUND

### Technical Field

The present disclosure relates to a motor vehicle including a front axle drivable via a drive arrangement.

### Description of the Related Art

A motor vehicle may have a purely rear-axle drive, a purely front-axle drive, or a drive via the rear axle as well as via the front axle. Electric motors are increasingly being used as drive units. If both a rear-axle drive and a front-axle drive are provided, the rear-axle drive is commonly used for continuous, primary driving performance and is configured accordingly. In many cases, an electric machine arranged in the center of the axle, commonly a synchronous machine, is used. The front-axle drive is primarily used to provide temporary additional power, wherein an electric machine in the form of an induction machine, also arranged in the center of the axle, is used as the drive unit.

A motor vehicle is known from EP2679425A1, which has four separate electric machines, wherein each electric machine is coupled to a wheel hub or drive hub of the rear axle or front axle. A central inverter arrangement is provided for the power supply, comprising four inverters, wherein each inverter controls or supplies an electric machine. A similarly configured motor vehicle is known from DE102022132659A1.

### BRIEF SUMMARY

A motor vehicle according to the present disclosure is provided, the motor vehicle may include a front axle configured to be driven via a drive arrangement, wherein the drive arrangement has a first electric motor with an associated first gearbox, which is coupled to a first drive hub, and a second electric motor with an associated second gearbox, which is coupled to a second drive hub. The first and the second electric motors may be induction motors, and a power supply device and a coolant and/or lubricant supply device arranged in a common structural unit may be provided. The first electric motor may be connected to the power supply device via a first power supply line arrangement and the second electric motor may be connected to the power supply device via a second power supply line arrangement, and the first electric motor and/or the first gearbox may be connected to the coolant and/or lubricant supply device via a first coolant and/or lubricant supply line arrangement and the second electric motor and/or the second gearbox may be connected to the coolant and/or lubricant supply device via a second coolant and/or lubricant supply line arrangement.

The motor vehicle according to the may include a compact structural unit comprising a power supply device and a coolant and/or lubricant supply device, wherein both electric motors, which are assigned to the respective front-axle wheel hubs, as well as corresponding gearboxes connected downstream of the electric motors, may be supplied via this structural unit.

The motor vehicle may have a first electric motor with an associated first gearbox, wherein the first gearbox may be downstream of the first electric motor and may be coupled to the first wheel hub of the front axle. A second electric motor with an associated second gearbox may also be provided, wherein the second gearbox may be downstream of the second electric motor and may be coupled to the second wheel hub of the front axle. This means that the respective wheel hubs may be driven directly.

The common structural unit comprising a power supply device and a coolant and/or lubricant supply device may be provided close to the front axle; in particular, the common structural unit may be located in the region between the two wheel hubs or drive hubs, i.e., as close as possible to the two electric motors or gearboxes, respectively. The power supply device may supply both electric motors, for which purpose two power supply line arrangements are provided. A first power supply line arrangement connects the power supply device to the first electric motor, and a second power supply line arrangement connects the power supply device to the second electric motor. Each electric motor may therefore be operated via the common power supply device, i.e., the respective stator of each respective electric motor may be supplied with a corresponding AC voltage. Both electric motors may be supplied and/or controlled separately.

The common structural unit may also comprise the coolant and/or lubricant supply device as described, via which both electric motors and/or both gearboxes may be supplied with a corresponding coolant and/or lubricant. For this purpose, the first electric motor and/or the first gearbox may be connected to the coolant and/or lubricant supply device via a first coolant and/or lubricant supply line arrangement. Likewise, the second electric motor and/or the second gearbox may be connected to the coolant or lubricant supply device via a second coolant and/or lubricant supply line arrangement. A common coolant and/or lubricant supply device may therefore also be provided, via which both electric motors and/or both gearboxes are supplied.

Such a configuration results in an extremely compact design, on the one hand, due to the combination of the power supply device and the coolant and/or lubricant supply device in a common structural unit, and, on the other hand, due to the arrangement of this structural unit as close as possible to the drive hubs, resulting in short connection distances between the structural unit and the respective device and the electric motors or gearboxes.

In some embodiments, such an arrangement according to the present disclosure is provided as an auxiliary drive arrangement, i.e., the motor vehicle comprises a rear-axle drive comprising a correspondingly powerful electric motor arranged in the center of the axle with an associated power supply device. This means that this rear-axle drive is provided separately from the front-axle drive. Both are decoupled from each other; only the power supply device for the front-axle drive or the rear-axle drive can be cooled via a common cooling circuit, wherein coolant water may be used as the coolant.

The cooling of the first and second electric motor on the front axle via the coolant and/or lubricant supply device integrated in the structural unit may be carried out using an oil that serves as a coolant and lubricant.

As described, the structural unit may be arranged in the region between the two drive hubs. This means that the structural unit may either be arranged in the axle connecting the two drive hubs, provided there is sufficient installation space in this region, or positioned slightly offset from the axle. In any case, the structural unit may be arranged as close as possible to the two drive hubs in order to make the front axle compact overall and to realize short connection distances.

In some embodiments, the power supply device may comprise a pulse width modulation inverter that generates a corresponding AC voltage from the DC voltage supplied by a battery storage device, with which the respective stators of the first and second electric machines, which may be configured as induction machines, may be supplied. This means that the power supply device in the structural unit may comprise only the pulse width modulation inverter, which is suitably connected to the battery storage device. The battery storage device may be located anywhere in the motor vehicle, especially as the battery storage device may also supply the electric motor of the rear axle.

The pulse width modulation inverter may serve both the first and the second electric motor, i.e., only one pulse width modulation inverter may be provided for supplying both electric motors.

In some embodiments, the first electric motor and/or the first gearbox as well as the coolant and/or lubricant device may be integrated into a first supply circuit via the first coolant and/or lubricant line arrangement, and that the second electric motor and/or the second gearbox as well as the coolant and/or lubricant device may be integrated into a second supply circuit via the second coolant and/or lubricant line arrangement. Two supply circuits may therefore be provided, into each of which an electric motor and/or the associated gearbox, on the one hand, and the coolant and/or lubricant device, on the other hand, may be integrated via the respective coolant and/or lubricant line arrangement. The first coolant and/or lubricant line arrangement may therefore have at least two coolant or lubricant lines that run from the structural unit to the first electric motor or to the first gearbox, i.e., a supply line and a return line. Likewise, the second coolant and/or lubricant line arrangement may have at least two coolant or lubricant lines that run from the structural unit to the second electric motor or to the second gearbox. As the respective electric motor may also be fluidically coupled to the gearbox, one connection of the two coolant or lubricant lines, either to the electric motor housing or to the gearbox housing, may be sufficient in order to supply both assemblies accordingly.

The coolant and/or lubricant supply device may comprise at least one tank containing the coolant and/or lubricant, at least one pump, and at least one heat exchanger. The tank contains the corresponding coolant and/or lubricant, preferably oil, which is distributed to the two circuits via the at least one pump. The oil may be cooled via the at least one heat exchanger.

In some embodiments, a first pump and a first heat exchanger may be integrated into the first supply circuit, and a second pump and a second heat exchanger may be integrated into the second supply circuit. In such embodiments, the two circuits are autonomous, i.e., not coupled to each other, so that the two circuits may be operated individually and the components can be cooled individually.

### BRIEF DESCRIPTION OF THE SEVERAL VIEWS OF THE DRAWINGS

FIG. 1 shows a schematic representation of a motor vehicle according to the disclosure.

FIG. 2 shows a schematic representation of a front axle of the motor vehicle shown in FIG. 1.

FIG. 3 shows a schematic representation of an electric motor together with a gearbox and power supply line arrangement, and coolant and/or lubricant supply line arrangement connected thereto.

### DETAILED DESCRIPTION

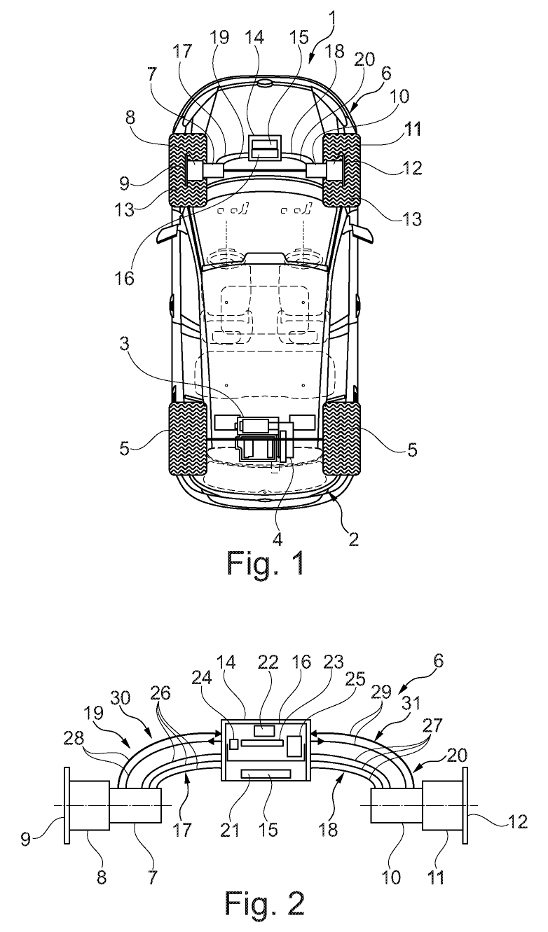

FIG. 1 shows a motor vehicle 1 according to the present disclosure, comprising a rear axle 2, which may be configured as an electric axle and may have an electric motor 3, which may be arranged centrally in relation to the rear axle, and a gearbox 4 coupled to the electric motor 3, via which the two rear wheels 5 are driven. The electric motor 3 may be configured as a correspondingly powerful synchronous motor, which may be configured as a permanently excited synchronous motor or as an externally excited synchronous motor. The primary drive of the motor vehicle 1 may be provided by the rear axle 2.

Furthermore, the motor vehicle 1 has a front axle 6, which may include a first electric motor 7 with an associated first gearbox 8, which outputs to a first drive hub 9, and a second electric motor 10 with an associated second gearbox 11, which outputs to a second drive hub 12. Wheel hub motors may therefore be provided, each with associated gearboxes, i.e., each front wheel 13 is driven directly by an electric motor 7 or 10.

Furthermore, a structural unit 14 may be provided in which a power supply device 15, which may be in the form of a pulse width modulation inverter 21, and a coolant and/or lubricant supply device 16 are integrated. This means that the power supply device 15 and the coolant and/or lubricant supply device 16 are combined to form a common power supply and coolant/lubrication unit, i.e., a compact structural unit. The structural unit 14 may be arranged as close as possible to the electric motors 7, 10 and thus to the drive hubs 9, 12, resulting in short connection distances and a compact axle design. The two electric motors 7, 10 and the associated gearboxes 8, 11 may be positioned as close as possible to the respective drive hubs 9, 12, which are coupled to the gearboxes 8, 11.

The structural unit 14 may be connected to the first electric motor 7 via a first power supply line arrangement 17 and to the second electric motor 10 via a second power supply line arrangement 18. Similarly, the structural unit 14 may be connected to the first electric motor 7 or the first gearbox 8 via a first coolant and/or lubricant supply line arrangement 19 and to the second electric motor 10 or the second gearbox 11 via a second coolant and/or lubricant supply line arrangement 20. The respective stator of the respective electric motor 7, 10 is supplied with an AC voltage provided by the power supply device 15 or the pulse width modulation inverter 21 via the power supply line arrangements in 17, 18, i.e., the respective electric motor 7, 10 is controlled and operated accordingly. The two coolant and/or lubricant supply line arrangements 19, 20 are used to supply the two electric motors 7, 10 and the two gearboxes 8, 11 with a coolant and/or lubricant, such as an oil that fulfills both functions. For this purpose, the coolant and/or lubricant supply device 16 may have corresponding components in the form of one or more pumps, one or more filters, one or more heat exchangers, and at least one tank that serves as a reservoir.

FIG. 2 shows an enlarged partial view of the front axle 6 in a schematic representation. The two electric motors 7, 10 and the associated gearboxes 8, 11, which may be, for example, planetary gearboxes, are shown. Also shown is the structural unit 14 with the power supply device 15, here in the form of a pulse width modulation inverter 21, and the coolant and/or lubricant supply device 16. A common pump 22, a common heat exchanger 23, and a common filter 24 are shown as examples, as is a tank 25.

Also shown are the first power supply line arrangement 17 and the second power supply line arrangement 18, both of which may be formed via the cables 26, 27 serving the three phases. The cables 26, 27 may be suitably connected to the power supply device 15 or the pulse width modulation inverter 21, respectively.

Also shown are the first coolant and/or lubricant supply line arrangement 19 and the second coolant and/or lubricant supply line arrangement 20, which each may be formed by two lines 28, 29, one of which is a supply line and the other a return line. The respective lines 28, 29 are likewise suitably connected to the coolant and/or lubricant supply device 16. A first supply circuit 30 may be formed via the lines 28, into which the coolant and/or lubricant supply device 16, as well as the first electric motor 7 and the first gearbox 8, are integrated. A second supply circuit 31 may be formed via the lines 29, in which the coolant and/or lubricant supply device 16, as well as the second electric motor 10 and the second gearbox 11, are also integrated. Only one pump 22 may be provided, which serves the two circuits 30, 31, which are formed via the lines 28, on the one hand, and the lines 29, on the other hand. A suitable valve unit that switches the respective flow may be provided for this purpose. Alternatively, a separate pump 22 may be assigned to each of the circuits 30, 31 formed via the lines 28, 29. The same applies to the heat exchanger 23; similarly, only one heat exchanger may be provided, which cools the entire coolant or lubricant circulating in both circuits 30, 31, or a separate heat exchanger 23 may be assigned to each circuit 30, 31. Only one filter 24 may also be provided, or a separate filter 24 may be assigned to each circuit 30, 31. The tank 25 may conveniently serve both circuits 30, 31. The individual components are connected to each other via suitable line connections.

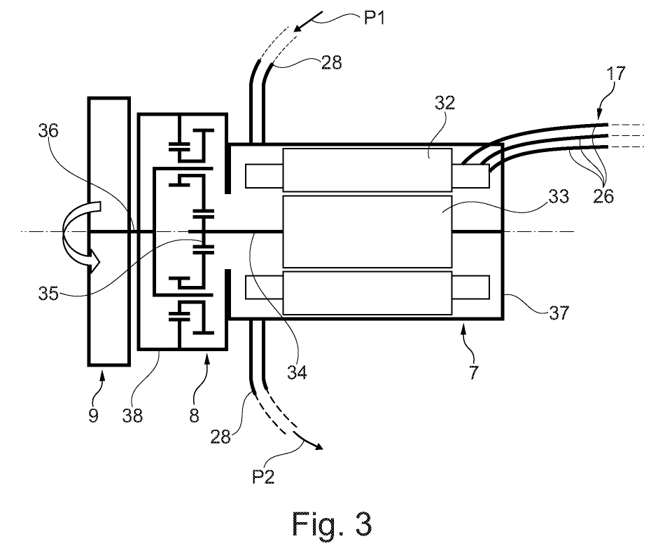

FIG. 3 shows a schematic representation of the first electric motor 7, the first gearbox 8, and the first drive hub 9 driven by the first drive hub 9. The following description applies in the same way to the design of the second electric motor 10, the second gearbox 11, and the further drive hub 12. The first electric motor 7, which may be configured as an induction motor, has a stator 32, which is connected to the lines 26 of the first power supply line arrangement 17 and is supplied via the lines 26 with the AC voltage delivered by the pulse width modulation inverter 21. Furthermore, a rotor 33 is provided, which may be coupled via an output shaft 34 thereof to a gearbox input 35 of the gearbox 8, shown here as a planetary gearbox. The gearbox 8 may be, in turn, connected via an output shaft 36 thereof to the wheel hub or drive hub 9, which is driven by the drive hub 9.

As FIG. 3 shows, a line 28 serving as a supply line may be connected to the housing 37 of the electric motor 7, via which the coolant or lubricant is supplied, as shown by arrow P1. The coolant or lubricant may be returned via a second line 28, which is connected to the housing 37, as shown by arrow P2. Since the electric motor 7 and the gearbox 8 are open to each other, i.e., are fluidically connected, the coolant or lubricant, i.e., the oil, may supply both components.

German patent application no. 102025103377.3, filed January 30, 2025, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A motor vehicle, comprising:
a front axle configured to be driven via a drive arrangement, wherein the drive arrangement includes:
a first electric motor configured as an induction motor;
a first gearbox associated with the first electric motor;
a first drive hub coupled to the first electric motor;
a second electric motor configured as an induction motor;
a second gearbox associated with the second electric motor; and
a second drive hub coupled to the second electric motor;
a power supply device; and
a coolant and/or lubricant supply device,
wherein the power supply device and the coolant and/or lubricant supply device are arranged in a common structural unit,
wherein the first electric motor is connected to the power supply device via a first power supply line arrangement and the second electric motor is connected to the power supply device via a second power supply line arrangement, and
wherein the first electric motor and/or the first gearbox are connected to the coolant and/or lubricant supply device via a first coolant and/or lubricant supply line arrangement and the second electric motor and/or the second gearbox are connected to the coolant and/or lubricant supply device via a second coolant and/or lubricant supply line arrangement.

2. The motor vehicle according to claim 1, wherein the structural unit is arranged in a region between the first drive hub and the second drive hub.

3. The motor vehicle according to claim 1, wherein the power supply device comprises a pulse width modulation inverter.

4. The motor vehicle according to claim 3, wherein the pulse width modulation inverter is configured to operate the first electric motor and the second electric motor.

5. The motor vehicle according to claim 1, wherein the first electric motor and/or the first gearbox, and the coolant and/or lubricant supply device, are integrated into a first supply circuit via the first coolant and/or lubricant supply line arrangement, and
wherein the second electric motor and/or the second gearbox, and the coolant and/or lubricant supply device, are integrated into a second supply circuit via the second coolant and/or lubricant supply line arrangement.

6. The motor vehicle according to claim 1, wherein the coolant and/or lubricant supply device comprises at least one tank configured to contain the coolant and/or lubricant, at least one pump, and at least one heat exchanger.

7. The motor vehicle according to claim 6, wherein a first pump of the at least one pump and a first heat exchanger of the at least one heat exchanger are integrated into the first supply circuit, and a second pump of the at least one pump and a second heat exchanger of the at least one heat exchanger are integrated into the second supply circuit.
